(19) United States
(12) Patent Application Publication
(10) Pub. No.: US 2002/0026952 A1
(43) Pub. Date: Mar. 7, 2002

(54) METHOD OF AND DEVICE FOR CLEANING SILICON WAFER, CLEANED SILICON WAFER, AND CLEANED SEMICONDUCTOR ELEMENT

(76) Inventors: NAOHIKO FUJINO, TOKYO (JP); HIROSHI TANAKA, TOKYO (JP); JUNJI KOBAYASHI, TOKYO (JP); JIRO NAKA, TOKYO (JP); YASUHIRO ASAOKA, TOKYO (JP); TAKUYA NOMOTO, TOKYO (JP)

Correspondence Address: LEYDIG VOIT & MAYER, LTD, 700 THIRTEENTH ST. NW, SUITE 300, WASHINGTON, DC, 20005-3960, US

(21) Appl. No.: 09/206,154

(22) Filed: Dec. 7, 1998

(30) Foreign Application Priority Data
Dec. 12, 1997 (JP) P 09-342656
Feb. 23, 1998 (JP) P 10-040141
Sep. 21, 1998 (JP) P 10-266263

(51) Int. Cl. B08B 3/12; B08B 7/00; B08B 7/04; B08B 3/00

(52) U.S. Cl. 134/1.3; 134/1; 134/23; 134/26; 134/28; 134/902

(57) ABSTRACT

A method of and a device for cleaning a silicon wafer, and a method of and a device for cleaning contamination metals and contamination particles adhered on the wafer surface at the same time.

The silicon wafer is cleaned by using a cleaning solution comprising an aqueous solution containing low concentration hydrogen fluoride of 0.0001 to 0.05% by weight and hydrogen peroxide while applying ultrasonic vibration to said cleaning solution. Alternatively, the silicon wafer is cleaned by dipping it in a cleaning solution comprising an aqueous solution prepared by dissolving hydrogen fluoride and ozone.

### BACKGROUND OF THE INVENTION

1. Field of the Invention

The present invention relates to a method of cleaning a silicon wafer and, more particularly, to a method of cleaning contamination metals and contamination particles at the same time. The present invention also relates to a device for performing the cleaning method. The present invention also relates to a silicon wafer cleaned by the method. Furthermore, the present invention relates to a semiconductor element cleaned by the method.

2. Description of the Related Art

LSI is produced by going through several hundreds of steps over several months. During such a long period of an operation time, semi-finished goods are exposed to various contaminations by transfer between the steps, leaving to stand or presence of operators. By minimizing these contaminations, the production yield of the device is improved and the reliability and reproducibility of the process can be remarkably improved. Therefore, it has hitherto been an important object to remove contaminants on the wafer surface by cleaning before various steps of the process.

For example, the minimum line width required to a design of DRAM (Dynamic Random Access Memory) of 64 Mbit is small such as 0.35 μm. To make it possible to perform such a fine working, a reduction in contamination caused by contamination particles in size of a fraction of the minimum line width and trace metals is required. Therefore, there has hitherto been used a cleaning method using a plurality of cleaning solutions, represented by the ACR cleaning method developed by Mr. Kern of RCA Co. U.S.A. in combination so as to remove contamination particles and trace metals.

The RCA cleaning method is a cleaning method comprising cleaning (SC1 cleaning) using a cleaning solution (solution prepared by dissolving ammonia and hydrogen peroxide in ultrapure water) capable of exerting a cleaning effect particularly to removal of contamination particles, and cleaning (SC2 cleaning) using cleaning solution (solution prepared by dissolving hydrochloric acid and hydrogen peroxide in ultrapure water) capable of exerting a cleaning effect particularly to removal of trace metals in combination. Detailed contents of the RCA cleaning method are described in W. Kern and D. Puotinenn: RCA Rev. 31, 187 (1970).

FIG. 3 is a schematic diagram showing a cleaning device for performing the RCA cleaning of the prior art. A product cassette 2 containing a wafer 1 before cleaning is loaded in a loader portion (loading portion) 21. The product cassette 2 is caught by a hand 5 via an elevating actuator 6 mounted to a locomotive robot 50, and then transferred to a cleaning bath 22 containing a cleaning solution 31 prepared by dissolving ammonia and hydrogen peroxide in ultrapure water by means of the locomotive robot 50.

The wafer 1 contained in the product cassette 2 is dipped in the cleaning bath 22 for a fixed time, thereby removing contamination particles (SC1 cleaning).

Then, the product cassette is transferred to a water washing bath 23 filled with ultrapure water 35 by means of the locomotive robot 50, where the wafer is subjected to a rinsing treatment.

Subsequently, the product cassette is transferred to a washing bath 24 filled with a cleaning solution 32 prepared by dissolving hydrogen chloride and hydrogen peroxide in ultrapure water by means of the locomotive robot 50, and contamination metals are removed by dipping in the cleaning bath 24 for a fixed time (SC2 cleaning).

Then, the cleaned wafer 1 is transferred in turn to a water washing bath 25 filled with ultrapure water 35, a spin drying device 26, and an unloader portion (unloading portion) 27, thereby completing a series of cleanings of the wafer 1.

The drying is performed by using the spin drying device, but the other drying means such as IPA drying device can also be used.

In the RCA cleaning method of the prior art, the SC1 cleaning is effective to remove contamination particles. However, there was a problem of secondary metal contamination wherein trace metal contamination on the wafer surface due to trace metals contained in the cleaning solution gets worse during the cleaning treatment. On the other hand, the SC2 cleaning is effective to remove trace metals, however, there was a problem of secondary particles contamination that particles contamination on the wafer surface due to particles contained in the cleaning solution gets worse.

In the RCA cleaning method of the prior art, use of a plurality of cleaning solutions is required. Therefore, the device used for cleaning requires baths for storing a plurality of cleaning solutions, and the size of the device became larger.

A plurality of cleanings is required to obtain a clean wafer surface and, therefore, a treating time required to the cleaning treatment becomes longer and throughput is also inferior. Furthermore, the total amount of chemicals increases and a large amount of ultrapure water is required to rinse the cleaning solution from the wafer surface. Therefore, the running cost of the cleaning step becomes higher and the amount of waste water increases, resulting in large loading to the global environment.

On the other hand, Japanese Patent Laid-Open (Kokai) Publication No. 213354/1996 suggests a method of removing contamination metals and contamination particles at the same time, which comprises dipping a wafer in a cleaning solution containing 0.05-20% by weight of hydrogen fluoride and 1-20% by weight of hydrogen peroxide, and cleaning the wafer using an ultrasonic wave. However, the particles are hardly removed, substantially, and the secondary contamination gets worse. According to such a method, the addition of a surfactant is essential to remove contamination particles to the degree capable of applying to VLSI. When the concentration of hydrogen peroxide is not less tan 10% by weight, it is difficult to sufficiently remove the particles even if the surfactant is added. The cleaning for removing the used surfactant from the wafer is required and, therefore, there is a problem that the cleaning step is complicated.

Therefore, the present inventors have intensively studied. As a result, they have found that contamination particles are drawn by a potential of the silicon surface of the silicon water to adhere on the surface of the silicon wafer, however, a film thickness of a silicon oxide film formed on the surface of the silicon wafer during the cleaning can be comparatively increased by adjusting the concentration of hydrogen fluoride in the cleaning solution to low concentration within a fixed range and adding hydrogen peroxide, thereby making it possible to reduce an influence of the potential of the surface of the silicon wafer and to reduce adhesion onto contamination particles.

Based on such a knowledge, the present inventors have succeeded in obtaining excellent cleaning effect in such a manner that contamination particles having weak adhesion are removed from the surface of the silicon wafer, together with etching of the silicon film, by etching the silicon oxide film of the surface of the silicon wafer using a cleaning solution containing predetermined low concentration hydrogen fluoride and hydrogen peroxide and further applying ultrasonic vibration. As a result, they have found that excellent cleaning effect is obtained without adding a surfactant.

Furthermore, the present inventors have intensively studied. As a result, they have found that contamination particles are drawn by a potential of the surface of the silicon water to adhere on the surface of the silicon wafer, however, a film thickness of a silicon oxide film formed on the surface of the silicon wafer during the cleaning can be comparatively increased by adjusting the concentration of hydrogen fluoride in the cleaning solution to low concentration within a fixed range and adding hydrogen peroxide. Consequently, they have also found that the potential of the surface of the silicon wafer is reduced, thereby making it possible to reduce adhesion of contamination particles.

Based on such a knowledge, ultrasonic vibration was applied while etching the silicon oxide film of the surface of the silicon wafer using a cleaning solution containing predetermined low concentration hydrogen fluoride and ozone. Consequently, the present inventors have succeeded in obtaining excellent cleaning effect by removing contamination particles having weak adhesion from the surface of the silicon wafer, together with etching of the silicon film. As a result, they have found that excellent cleaning effect is obtained without adding a surfactant.

### SUMMARY OF THE INVENTION

The present invention has been accomplished based on the above knowledges, and an object of the present invention is to provide a cleaning method exerting no harmful influence on the global environment, which can solve a problem of secondary contamination generated at the time of cleaning and can remove contamination metals and contamination particles adhered on the wafer at the same time to the level capable of applying to the step of producing VLSI, and which can reduce kinds of cleaning solutions to be used and an amount of chemical solutions to be used.

Another object of the present invention is to provide a portable cleaning device having high throughput, which can realize the cleaning method.

Still another object of the present invention is to provide a silicon wafer cleaned by the cleaning method.

A further object of the present invention is to provide a semiconductor element cleaned by the cleaning method.

Therefore, the present inventors have intensively studied. As a result, they have found that contamination metals and contamination particles adhered on the wafer can be removed at the same time to the degree capable of applying to the step of producing VLSI by washing the wafer by using a cleaning solution comprising an aqueous solution containing low concentration hydrogen fluoride of 0.0001 to 0.05% by weight and hydrogen peroxide while applying ultrasonic vibration to said cleaning solution without adding a surfactant. Thus, the present invention has been completed.

That is, the present invention provides a method of cleaning a silicon wafer, which comprises dipping the silicon wafer in a cleaning solution comprising an aqueous solution containing low concentration hydrogen fluoride and hydrogen peroxide while applying ultrasonic vibration to the silicon wafer.

By such a method, contamination particles and contamination trace metal, which have been removed in a separate step according to the RCA method of the prior art, can be removed at the same time, thereby making it possible to simplify the cleaning step and to reduce secondary contamination.

Particularly, by removing contamination particles and contamination trace metals at the same time, readhesion of the other contaminant in the step of removing one contaminant, which have occurred in the RCA method of the prior art, can be prevented, thereby making it possible to obtain a clean silicon wafer with little contamination and to obtain a remarkably clean wafer surface required to the step of producing DRAM.

Since only one kind of a cleaning solution is used and its concentration is very low, it becomes possible to reduce the amount of the solution and ultrapure water required to rinse the cleaning solution from the wafer surface.

Furthermore, such a cleaning step accompanies the etching reaction of silicon oxide due to hydrogen fluoride but the cleaning solution can be used at room temperature and, therefore, the etch rate can be easily controlled. Also, energy required to heat the cleaning solution is not required.

On the other hand, the method of the present invention is different from a cleaning method using low concentration hydrogen fluoride and hydrogen peroxide disclosed, for example, in Japanese Patent Laid-Open (Kokai) Publication No. 115077/1995. That is, the method described in the above publication is different from that of the present invention in that ultrasonic vibration is not used and the cleaning is performed at high temperature (e.g. 80° C.). Particularly, since the etch rate of hydrogen fluoride depends largely on the temperature, such a cleaning method accompanying the etching of silicon oxide formed on the surface of the silicon wafer essentially requires use of a thermostatic bath, resulting in the complicated/unstable cleaning step. Accordingly, it is very advantageous to obtain a silicon wafer having a remarkably clean surface in view of the production step, like the present invention. Since no ultrasonic wave is applied in the method described in the above publication, it is very difficult to remove particles, substantially. Therefore, it is essentially difficult to remove the particles to the level required to the production of DRAM.

The concentration of hydrogen fluoride is preferably from 0.0001 to 0.05% by weight.

It becomes possible to remove contamination particles and contamination trace metals at the same time without adding a surfactant by using low concentration hydrogen fluoride and hydrogen peroxide as well as a physical removing force of ultrasonic vibration in such way.

The concentration of hydrogen fluoride is preferably from 0.001 to 0.05% by weight. It becomes possible to reduce contamination particles within such a range.

The concentration of hydrogen fluoride is from 0.001 to 0.03% by weight, more preferably.

The concentration of hydrogen peroxide is preferably from 0.0001 to 50% by weight.

The vibration frequency of ultrasonic vibration is preferably not less than 100 kHz.

It is essential for the method of the present invention to apply ultrasonic vibration because a harmful influence such as peeling of film caused by cavitation to the device such as DRAM can be avoided by using the frequency of not less than 100 kHz.

The present invention also provides a cleaning bath for storing a cleaning solution comprising an aqueous solution containing low concentration hydrogen fluoride and hydrogen peroxide, said cleaning bath further comprising an ultrasonic wave generator for applying ultrasonic vibration to a silicon wafer dipped in the cleaning solution.

By using a material, which does not dissolve in hydrogen fluoride, in the cleaning bath, it becomes possible to provide a cleaning device which is superior in safety and durability.

In case of periodically replacing the cleaning bath, since low concentration hydrogen fluoride is used in the present invention, the rate of etching to quartz is low. Therefore, a cleaning bath made of quartz of the prior art may also be used.

It is essential for such a cleaning method of the present invention to apply ultrasonic vibration, and the cleaning bath is preferably equipped with an ultrasonic wave generator.

The cleaning bath is preferably made of silicon carbide. Because silicon carbide is superior in safety and durability, and hardly causes damping of ultrasonic vibration.

The present invention also provides a device for cleaning a silicon wafer, comprising a cleaning bath, a water washing bath for washing a silicon wafer cleaned in the cleaning bath, and a drier for drying the silicon wafer washed with water in the water washing bath.

The present invention also provides a silicon wafer cleaned by dipping in a cleaning solution comprising an aqueous solution containing low concentration hydrogen fluoride and hydrogen peroxide while applying ultrasonic vibration.

By using such a silicon wafer, it becomes possible to improve the production yield of DRAM.

Furthermore, the present inventors have intensively studied. As a result, they have found that contamination metals and contamination particles can be removed at the same time to the degree capable of applying to the step of producing VLSI by dipping a silicon wafer in a cleaning solution comprising an aqueous solution prepared by dissolving not less than 0.0001% by weight of hydrogen fluoride and ozone, without adding a surfactant. Thus, the present invention has been completed.

That is, the present invention also provides a method of cleaning a silicon wafer, which comprises dipping a silicon wafer in a cleaning solution comprising an aqueous solution prepared by dissolving not less than 0.0001% by weight of hydrogen fluoride and ozone.

The concentration of hydrogen fluoride is preferably not less than 0.0005% by weight.

The concentration of hydrogen fluoride is preferably from 0.005 to 0.3% by weight.

The concentration of hydrogen fluoride is preferably from 0.01 to 0.1% by weight.

The concentration of ozone in the cleaning solution is preferably not less than 0.05 ppm.

The concentration of ozone in the cleaning solution is preferably not less than 0.1 ppm.

The present invention also provides a method of cleaning a silicon wafer, which comprises dipping a silicon wafer in a cleaning solution comprising an aqueous solution prepared by dissolving 0.0005-0.5% by weight of hydrogen fluoride and not less than 0.1 ppm of ozone, and applying ultrasonic wave of not less than 100 kHz to the cleaning solution.

The cleaning solution may comprise an aqueous solution prepared by dissolving 0.001-0.3% by weight of hydrogen peroxide and not less than 2 ppm of ozone.

The cleaning solution may comprise an aqueous solution prepared by dissolving 0.005-0.05% by weight of hydrogen fluoride and not less than 2 ppm of ozone.

The present invention also provides a device for cleaning a silicon wafer, comprising a loader chamber, a cleaning bath filled with a cleaning solution prepared by dissolving hydrogen fluoride and ozone, an ultrasonic generating means for applying ultrasonic wave to the cleaning solution, the ultrasonic generating means being mounted to the cleaning bath, and a transfer means for transferring the wafer from the loader chamber to the cleaning bath.

The present invention also provides a device for cleaning a silicon wafer, comprising a loader chamber, a cleaning bath filled with a cleaning solution prepared by dissolving hydrogen fluoride and ozone, an ultrasonic generating means for applying ultrasonic wave to the cleaning solution, the ultrasonic generating means being mounted to the cleaning bath, and a transfer means for transferring the wafer from the loader chamber to the cleaning bath, wherein the concentration of hydrogen fluoride is controlled within a range from 0.0005 to 0.5% by weight and the concentration of ozone is controlled to not less than 0.1 ppm, and wherein the ultrasonic generating means is capable of applying an ultrasonic wave of not less than 100 kHz to the cleaning solution.

The concentration of hydrogen fluoride is preferably controlled within a range from 0.001 to 0.3% by weight, whereas, the concentration of ozone is preferably controlled to not less than 2 ppm.

The concentration of hydrogen fluoride is preferably controlled within a range from 0.005 to 0.05% by weight, whereas, the concentration of ozone is preferably controlled to not less than 2 ppm.

The present invention also provides a silicon wafer cleaned by dipping in a cleaning solution comprising an aqueous solution prepared by dissolving not less than 0.0001% by weight of hydrogen fluoride and ozone.

The present invention also provides a semiconductor element wafer cleaned by dipping in a cleaning solution comprising an aqueous solution prepared by dissolving not less than 0.0001% by weight of hydrogen fluoride and ozone.

The present invention also provides a semiconductor element cleaned by dipping in a cleaning solution comprising an aqueous solution prepared by dissolving 0.0005-0.5% by weight of hydrogen fluoride and not less than 0.1 ppm of ozone, and cleaning by applying an ultrasonic wave of not less than 100 kHz to the cleaning solution.

The present invention also provides a semiconductor element cleaned by using a cleaning device comprising a cleaning bath and an ultrasonic generating means for applying an ultrasonic wave of not less than 100 kHz in the cleaning bath, the ultrasonic generating means being mounted to the cleaning bath, wherein the cleaning bath is filled with a cleaning solution comprising an aqueous solution prepared by dissolving 0.0005-0.5% by weight of hydrogen fluoride and not less than 0.1 ppm of ozone.

According to the present invention, contamination particles and contamination trace metals can be removed at the same time. Therefore, a problem of secondary contamination, which occurs during the cleaning, can be eliminated. Since only one kind of a cleaning solution is used, a potable cleaning device having high throughput can be provided. When only one kind of a cleaning solution is used, since its concentration is very small, it becomes possible to reduce the amount of ultrapure water required to rinse the cleaning solution from the wafer surface. Therefore, realization of a cleaning process causing no harmful influence on the global environment and realization of a potable cleaning device having high throughput can be attained. Furthermore, there can be obtained a silicon wafer wherein contamination particles and contamination trace metals are removed. There can also be obtained a semiconductor element wherein contamination particles and contamination trace metals are removed.

### BRIEF DESCRIPTION OF THE DRAWINGS

FIG. 1 is a schematic diagram showing the construction of the cleaning device of one example according to the present invention.

FIG. 2 is a schematic diagram showing the construction of the cleaning device of another example according to the present invention.

FIG. 3 is a schematic diagram showing the construction of the cleaning device used in the RCA cleaning method of the prior art.

### DESCRIPTION OF THE PREFERRED EMBODIMENTS

The following Examples and Comparative Examples further illustrate the embodiments of the present invention.

First, a method of preparing a wafer for evaluation of the cleaning effect of metal contamination (hereinafter referred to as a “metal contaminated wafer 52”) and a method of preparing a wafer for evaluation of the cleaning effect of particles contamination (hereinafter referred to as a “particles contaminated wafer 53”) will be described. The wafer used in the evaluation is a 6 inch silicon wafer, Model FZ manufactured by Shin-etsu Silicon Co., Ltd.

The metal contaminated wafer 52 was obtained by taking off a seal coat of a 6 inch silicon wafer, Model FZ manufactured by Shin-etsu Silicon Co., Ltd.; dipping the silicon wafer in a contamination solution, which is prepared by respectively adding a solution of ferric nitrate, aluminum chloride, nickel nitrate, zinc sulfide and calcium chloride to a cleaning solution prepared by dissolving ammonia and hydrogen peroxide in ultrapure water, in the amount of 1 ppm in terms of a concentration by weight for 10 minutes; washing with water for 10 minutes; subjecting to a spin drying treatment; and allowing to stand in a clean room (air) for 60 hours to perform air drying; for the purpose of performing metal contamination of the wafer surface.

The particles contaminated wafer 53 was obtained by taking off a seal coat of a 6 inch silicon wafer, Model FZ manufactured by Shin-etsu Silicon Co., Ltd.; and scattering tens of hundreds of polystyrene latex standard particles having a particle diameter of 0.2 μm, which are commercially available from Nippon Gosei Gomu Co., Ltd. under the trade name of STADEX® using a particles scattering device, Model JSR AEROMASTER-1® manufactured by Nippon Gosei Gomu Co., Ltd.

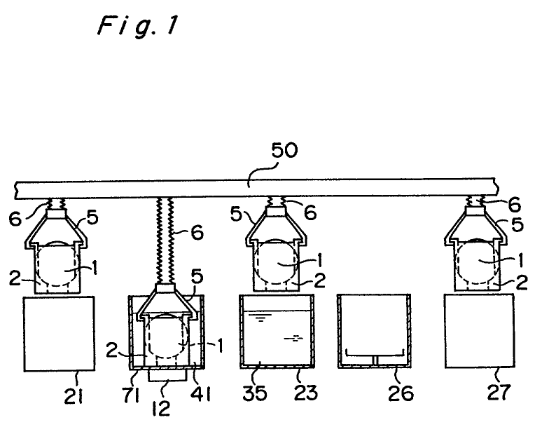

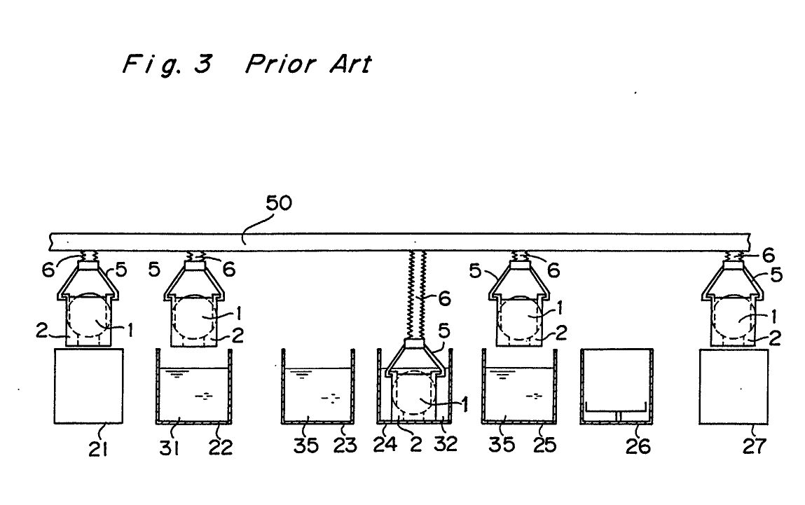

These contaminated wafers were cleaned by using the cleaning device according to the present invention shown in FIG. 1 for 10 minutes. In FIG. 1, the same reference symbols as those in FIG. 3 respectively denote the same or corresponding positions, and 12 denotes an ultrasonic generator, 41 denotes a cleaning solution and 71 denotes a cleaning bath.

It is preferred to use, as the material of the cleaning bath 71, silicon carbide which is superior in corrosion resistance and hardly causes damping.

The cleaning effect was evaluated by measuring (1) a level of metal contamination of the wafer surface (concentration of iron atom) and (2) a level of particles contamination of the wafer surface (number of particles having a particle diameter of not less than 0.2 μm) after and before cleaning, using a total reflection fluorescent X-ray device (Model TREX®, manufactured by Technos Co.) and a dust particle inspection device (Model LS-6000®, manufactured by Hitachi Electron Engineering Co., Ltd.).

As a result, Fe (2×10¹³ atoms/cm²), Ni (not more than detection limit, not more than 3×10¹⁰ atoms/cm²), Zn (4×10¹⁰ atoms/cm²) and Ca (5×10¹⁰ atoms/cm²) were respectively detected on the metal contaminated wafer 52 inspected by the total reflection fluorescent X-ray device. Although Al could be detected, quantitative determination could not be performed because of a strong influence of silicon as a substrate.

On the other hand, the concentration of each metal contamination atom on the particles contaminated wafer 53 was low, that is, not more than the detection limit (3×10¹⁰ atoms/cm²) of the total reflection fluorescent X-ray device.

It has been found that about 5000 polystyrene latex standard particles (hereinafter referred to as PSL) were adhered on the particles contaminated wafer 53 inspected by the dust particle inspection device.

About 6000 adhered particles were also observed on the metal contaminated wafer 52. This is because ferric nitrate, aluminum chloride, nickel nitrate, zinc sulfide and calcium chloride are chemically reacted each other in the cleaning solution prepared by dissolving ammonia and hydrogen peroxide in ultrapure water to deposit ferric hydroxide and aluminum hydroxide in the form of particles, which are adhered on the wafer. It is considered that ferric hydroxide and aluminum hydroxide are air-dried for 60 hours to form metal oxide particles such as ferric oxide particles and alumina particles on the wafer.

### EXAMPLE 1

The cleaning method of the present invention will be applied to the above metal contaminated wafer 52 and particles contaminated wafer 53, thereby to evaluate the contaminated state before and after cleaning.

That is, the above metal contaminated wafer 52 and particles contaminated wafer 53 were cleaned by dipping each silicon wafer for evaluation in a cleaning solution comprising an aqueous solution containing a predetermined concentration of hydrogen fluoride and 1.0% (fixed) by weight of hydrogen peroxide, applying an ultrasonic wave of not less than 10 kHz to the cleaning solution for 10 minutes, and then drying the cleaned silicon wafer at room temperature.

Specifically, in FIG. 1, 21 is a loader 21 provided to load a product cassette 2 containing a wafer 1 into a cleaning device. The product cassette 2 containing the loaded wafer 1 is caught by a hand 5 through an elevating actuator 6 mounted to a locomotive robot 50, and then loaded in a cleaning bath 7 filled with a cleaning solution 41 prepared by dissolving hydrogen fluoride and hydrogen peroxide in ultrapure water, where contamination particles and contamination metals are cleaned at the same time.

An ultrasonic generator 12 (manufactured by Honda Denshi Co., Ltd., frequency: 800 kHz, dissipation power: 30 W) is mounted to the exterior of this cleaning bath 71, thereby to apply ultrasonic vibration to the wafer 1. The cleaning bath 71 is made of silicon carbide as a material, which does not dissolve in the cleaning solution 41 and hardly causes damping of an ultrasonic wave generated from the ultrasonic generator 12 mounted to the exterior of the cleaning bath 71.

Then, the product cassette 2 and wafer 1 are transferred to a water washing bath filled with ultrapure water 35 by means of the locomotive robot 50, where they are subjected to a rinsing treatment to rinse the cleaning solution 41 adhered on the surface.

Then, the production cassette 2 and wafer are transferred to a spin drying device 26 by means of the locomotive robot 50, where they are dried. The dried product cassette 2 and wafer 1 are transferred to an unloader 27 by means of the locomotive robot 50, where they are unloaded.

The drying shown in this process is performed by using a spin drying device, but other drying devices such as IPA drying device and Marangoni drying device can also be used, not limited to the spin drying device.

The evaluation results of the metal contaminated wafer cleaned in the same manner as that described above are shown in Tables 1 and 2 below.

TABLE 1

| HF | Fe | Ni | Zn | Ca | |
|---|---|---|---|---|---|
| concentration | (atoms/ | (atoms/ | (atoms/ | (atoms/ | PSL |
| (wt. %) | cm²) | cm²) | cm²) | cm²) | particles |
| Before cleaning | 2 × 10¹³ | <3 × 10¹⁰ | 4 × 10¹⁰ | 5 × 10¹⁰ | ˜6000 |
| 0.00000 | 6 × 10¹² | <3 × 10¹⁰ | 4 × 10¹⁰ | 5 × 10¹⁰ | 5924 |
| 0.00001 | 6 × 10¹² | <3 × 10¹⁰ | 4 × 10¹⁰ | 5 × 10¹⁰ | 5883 |
| 0.00005 | 5 × 10¹² | <3 × 10¹⁰ | <3 × 10¹⁰ | 5 × 10¹⁰ | 6046 |
| 0.00010 | 5 × 10¹² | <3 × 10¹⁰ | <3 × 10¹⁰ | 4 × 10¹⁰ | 5908 |
| 0.00050 | 3 × 10¹² | <3 × 10¹⁰ | <3 × 10¹⁰ | <3 × 10¹⁰ | 5756 |
| 0.00100 | 1 × 10¹² | <3 × 10¹⁰ | <3 × 10¹⁰ | <3 × 10¹⁰ | 5991 |
| 0.00500 | 6 × 10¹¹ | <3 × 10¹⁰ | <3 × 10¹⁰ | <3 × 10¹⁰ | 6568 |
| 0.01000 | 1 × 10¹¹ | <3 × 10¹⁰ | <3 × 10¹⁰ | <3 × 10¹⁰ | 5811 |
| 0.03000 | <3 × 10¹⁰ | <3 × 10¹⁰ | <3 × 10¹⁰ | <3 × 10¹⁰ | 6353 |
| 0.05000 | <3 × 10¹⁰ | <3 × 10¹⁰ | <3 × 10¹⁰ | <3 × 10¹⁰ | 7451 |
| 0.10000 | <3 × 10¹⁰ | <3 × 10¹⁰ | <3 × 10¹⁰ | <3 × 10¹⁰ | 8231 |
| 0.30000 | <3 × 10¹⁰ | <3 × 10¹⁰ | <3 × 10¹⁰ | <3 × 10¹⁰ | 8841 |
| 0.50000 | <3 × 10¹⁰ | <3 × 10¹⁰ | <3 × 10¹⁰ | <3 × 10¹⁰ | 8626 |
| 1.00000 | <3 × 10¹⁰ | <3 × 10¹⁰ | <3 × 10¹⁰ | <3 × 10¹⁰ | 9535 |

TABLE 2

| HF | Fe | Ni | Zn | Ca | |
|---|---|---|---|---|---|
| concentration | (atoms/ | (atoms/ | (atoms/ | (atoms/ | PSL |
| (wt. %) | cm²) | cm²) | cm²) | cm²) | particles |
| Before cleaning | 2 × 10¹³ | <3 × 10¹⁰ | 4 × 10¹⁰ | 5 × 10¹⁰ | ˜6000 |
| 0.00000 | 5 × 10¹² | <3 × 10¹⁰ | 4 × 10¹⁰ | 5 × 10¹⁰ | 3583 |
| 0.00001 | 5 × 10¹² | <3 × 10¹⁰ | 4 × 10¹⁰ | 5 × 10¹⁰ | 3605 |
| 0.00005 | 4 × 10¹² | <3 × 10¹⁰ | <3 × 10¹⁰ | 5 × 10¹⁰ | 3069 |
| 0.00010 | 2 × 10¹² | <3 × 10¹⁰ | <3 × 10¹⁰ | 4 × 10¹⁰ | 1316 |
| 0.00050 | 1 × 10¹² | <3 × 10¹⁰ | <3 × 10¹⁰ | <3 × 10¹⁰ | 226 |
| 0.00100 | <3 × 10¹⁰ | <3 × 10¹⁰ | <3 × 10¹⁰ | <3 × 10¹⁰ | 38 |
| 0.00500 | <3 × 10¹⁰ | <3 × 10¹⁰ | <3 × 10¹⁰ | <3 × 10¹⁰ | 20 |
| 0.01000 | <3 × 10¹⁰ | <3 × 10¹⁰ | <3 × 10¹⁰ | <3 × 10¹⁰ | 27 |
| 0.03000 | <3 × 10¹⁰ | <3 × 10¹⁰ | <3 × 10¹⁰ | <3 × 10¹⁰ | 21 |
| 0.05000 | <3 × 10¹⁰ | <3 × 10¹⁰ | <3 × 10¹⁰ | <3 × 10¹⁰ | 423 |
| 0.10000 | <3 × 10¹⁰ | <3 × 10¹⁰ | <3 × 10¹⁰ | <3 × 10¹⁰ | 5830 |
| 0.30000 | <3 × 10¹⁰ | <3 × 10¹⁰ | <3 × 10¹⁰ | <3 × 10¹⁰ | 10356 |
| 0.50000 | <3 × 10¹⁰ | <3 × 10¹⁰ | <3 × 10¹⁰ | <3 × 10¹⁰ | 23381 |
| 1.00000 | <3 × 10¹⁰ | <3 × 10¹⁰ | <3 × 10¹⁰ | <3 × 10¹⁰ | 32933 |

Table 1 shows the case where no ultrasonic wave is applied, whereas, Table 2 shows the case where an ultrasonic wave (800 kHz) is applied.

Using, as a cleaning solution 33, a cleaning solution prepared by adding hydrogen fluoride having a different concentration ranging from 0 to 1.0% by weight to a solution prepared by dissolving 1% by weight of hydrogen peroxide, the cleaning was performed at room temperature for 10 minutes. The rinsing was performed by washing with ultrapure water for 10 minutes.

As is apparent from the case of applying no ultrasonic wave shown in Table 1, Fe as the contamination metal is removed until the concentration reaches a detection limit (3×10¹⁰ aroms/cm²) or less when the concentration of hydrogen fluoride is not less than 0.03% by weight.

As is apparent from the case where the cleaning was performed by applying an ultrasonic wave shown in Table 2, the concentration of Fe reaches a detection limit (3×10¹⁰ aroms/cm²) or less even if the concentration of hydrogen fluoride is 0.001% by weight.

The characteristics of removing contamination metals do not depend largely on the concentration of hydrogen peroxide, and a remarkable difference was not recognized in the concentration of hydrogen peroxide within a range from 0.05 to 50% by weight.

With respect to the characteristics of removing contamination particles (metal oxide particles), as shown in Table 1, when no ultrasonic wave is applied, the number of dust particles is not less than 1000 and the particles are not easily removed. It is recognized that particles contamination has got worse when the concentration of hydrogen fluoride is not less than 0.05% by weight.

On the other hand, in case of applying an ultrasonic wave, the number of dust particles can be reduced to 100 in the concentration of hydrogen fluoride within a range from 0.001 to 0.05% by weight. Therefore, a remarkable effect of removing the metal oxide particles is recognized.

However, when the concentration of hydrogen fluoride is not less than 0.1% by weight, it gradually becomes difficult to remove the particles. The reason is considered that once removed metal oxide particles are easily adsorbed again on the wafer during the cleaning and, therefore, secondary contamination has got worse.

As is apparent from these results, not only selection of an optimum concentration of hydrogen fluoride is required but also application of ultrasonic vibration is essential to remove contamination metals and contamination particles, thereby obtaining a clean silicon wafer.

The characteristics of removing these contamination particles (metal oxide particles) do not largely depend on the concentration of hydrogen peroxide, and a remarkable difference was not recognized in the concentration of hydrogen peroxide within a range from 0.05 to 50% by weight.

However, in case of adding no hydrogen peroxide, the metal oxide particles were not sufficiently removed.

### EXAMPLE 2

In Example 2, the cleaning was performed by using the particles contaminated wafer 53 in place of the metal contaminated wafer 52 used in Example 1. The cleaning conditions are the same as those of Example 1.

The wafer was cleaned with or without applying ultrasonic vibration (800 kHz) for 10 minutes and the number of dust particles (number of particles having a particle diameter of not less than 0.2 μm), which are present on the wafer surface, was measured. The results are shown in Table 3.

TABLE 3

| HF | | |
|---|---|---|
| concentration | PSL particles | PSL particles |
| (wt. %) | (without ultra sonic) | (with ultra sonic) |
| Before cleaning | ˜5000 | ˜5000 |
| 0.00000 | 5020 | 727 |
| 0.00001 | 4987 | 863 |
| 0.00005 | 4911 | 425 |
| 0.00010 | 5245 | 251 |
| 0.00050 | 5013 | 142 |
| 0.00100 | 4808 | 67 |
| 0.00500 | 5150 | 25 |
| 0.01000 | 5008 | 19 |
| 0.03000 | 4985 | 25 |
| 0.05000 | 5915 | 62 |
| 0.10000 | 5804 | 851 |
| 0.30000 | 6001 | 5295 |
| 0.50000 | 7080 | 8351 |
| 1.00000 | 8511 | 9035 |

As is apparent from the results, when ultrasonic vibration is applied, the number of dust particles does not depend on the concentration of hydrogen fluoride and is about 1000 in any case and, furthermore, dust particles (PSL particles) are not easily removed in the absence of ultrasonic vibration. To the contrary, particles contamination may have got worse when the concentration of hydrogen fluoride is not less than 0.3% by weight.

In case of cleaning with applying an ultrasonic wave, remarkable removal of contamination particles (PSL particles) is recognized when the concentration of hydrogen fluoride is within a range from 0.00005 to 0.1% by weight. However, it gradually becomes difficult to remove contamination particles when the concentration is not less than 0.3% by weight. To the contrary, particles contamination may have got worse when the concentration of hydrogen fluoride is not less than 0.05% by weight.

This reason is considered that contamination particles (PSL particles), which were removed once from the wafer surface by cleaning, and other unconfirmed particles adhered on the back surface of the wafer are easily adhered again during the cleaning.

As is apparent from these results, selection of an optimum concentration of hydrogen fluoride and application of ultrasonic vibration are required to remove contamination particles, thereby obtaining a clean wafer.

The characteristics of removing contamination particles (PSL particles) do not depend largely on the concentration of hydrogen peroxide and a remarkable difference was not recognized within a range from 0.05 to 50% by weight.

However, contamination particles could hardly be removed when any hydrogen peroxide is not added.

### COMPARATIVE EXAMPLE 1

In this Comparative Example, a cleaning effect was examined when the SC1 cleaning of the prior art was performed. The silicon wafer was cleaned under the same conditions as those of Example 1, except for using a cleaning solution 34 (ammonia:hydrogen peroxide:pure water=1:1:15) prepared by dissolving ammonia and hydrogen peroxide in pure water in place of the cleaning solution 41 used in Example 1, and the evaluation was performed.

Using the cleaning solution 34 prepared by dissolving ammonia and hydrogen peroxide in pure water, the metal contaminated wafer 52 and particles contaminated wafer 53 were cleaned under the conditions in the presence/absence of ultrasonic vibration at room temperature for 10 minutes (SC1 cleaning) and the concentration of atoms such as Fe and the number of dust particles (number of particles having a particle diameter of not less than 0.2 μm) of the wafer surface were measured. The results are shown in Table 4.

TABLE 4

| | Fe | Ni | Zn | Ca | PSL |
|---|---|---|---|---|---|
| | (atoms/cm²) | (atoms/cm²) | (atoms/cm²) | (atoms/cm²) | particles |
| Metal contaminated wafer | 2 × 10¹³ | <3 × 10¹⁰ | 4 × 10¹⁰ | 5 × 10¹⁰ | ˜6000 |
| 52 (before cleaning) | | | | | |
| Without ultra sonic | 5 × 10¹² | <3 × 10¹⁰ | 4 × 10¹⁰ | 4 × 10¹⁰ | 1386 |
| With ultra sonic | 6 × 10¹² | <3 × 10¹⁰ | 4 × 10¹⁰ | 5 × 10¹⁰ | 25 |
| Particles contaminated | <3 × 10¹⁰ | <3 × 10¹⁰ | <3 × 10¹⁰ | <3 × 10¹⁰ | ˜5000 |
| wafer 53 (before cleaning) | | | | | |
| Without ultra sonic | 6 × 10¹⁰ | <3 × 10¹⁰ | 4 × 10¹⁰ | 5 × 10¹⁰ | 435 |
| With ultra sonic | 1 × 10¹¹ | <3 × 10¹⁰ | 4 × 10¹⁰ | 6 × 10¹⁰ | 21 |

First, with respect to particles contamination (number of dust particles), in case of applying no ultrasonic vibration, slightly good results were obtained compared with the results of the number of dust particles obtained in the Examples of the present invention, shown in Tables 1 and 3, in case of applying ultrasonic vibration. The number of dust particles is 1386 in case of the metal contaminated wafer 52, and is 435 in case of the particles contaminated wafer 53.

On the other hand, when an ultrasonic wave is applied, almost the same number (about 30) of dust particles as that in case of the cleaning results under optimum cleaning conditions of Table 2 (concentration of hydrogen fluoride: 0.001 to 0.03% by weight) was obtained in both cases of the metal contaminated wafer 52 and particles contaminated wafer 53. The results show that excellent cleaning effect is obtained.

With respect to the metal contamination, the metal contamination level of the wafer surface after cleaning to the metal contaminated wafer 52 was high, that is, the concentration of Fe atom is 5×10¹² atoms/cm² in the absence of ultrasonic vibration, whereas, the concentration is 6×10¹² atoms/cm² in the presence of ultrasonic vibration. The level of other metals such as Zn, Ca and the like became high.

With respect to the metal contamination level of the wafer surface after cleaning to the particles contaminated wafer 53, the concentration of Fe atom is 6×10¹⁰ atoms/cm² in the absence of ultrasonic vibration, whereas, the concentration is 1×10¹¹ atoms/cm² in the presence of ultrasonic vibration. That is, the concentration became slightly higher than that of the contaminated state before cleaning (not more than 3×10¹⁰ atoms/cm²).

Summarizing these results, it has been found that these cleaning method according to the present invention shown in Examples 1 and 2 is particularly superior in effect of removing the contamination metal to the cleaning method (SC1 cleaning) of the prior art shown in Comparative Example 1.

### COMPARATIVE EXAMPLE 2

In this Comparative Example, a cleaning effect was examined when the SC2 cleaning of the prior art was performed. The silicon wafer was cleaned under the same conditions as those of Example 1, except for using a cleaning solution 35 (hydrochloric acid:hydrogen peroxide:pure water=1:1:15) prepared by dissolving hydrochloric acid and hydrogen peroxide in pure water in place of the cleaning solution 41 used in Example 1, and the evaluation was performed.

Using the cleaning solution 35, the metal contaminated wafer 52 and particles contaminated wafer 53 were cleaned under the conditions in the presence/absence of ultrasonic vibration at room temperature for 10 minutes, and the concentration of atoms of various metals and the number of dust particles (number of particles having a particle diameter of not less than 0.2 μm) of the wafer surface were measured. The results are shown in Table 5.

TABLE 5

| | Fe | Ni | Zn | Ca | PSL |
|---|---|---|---|---|---|
| | (atoms/cm²) | (atoms/cm²) | (atoms/cm²) | (atoms/cm²) | particles |
| Metal contaminated wafer | 2 × 10¹³ | <3 × 10¹⁰ | 4 × 10¹⁰ | 5 × 10¹⁰ | ˜6000 |
| 52 (before cleaning) | | | | | |
| Without ultra sonic | <3 × 10¹⁰ | <3 × 10¹⁰ | <3 × 10¹⁰ | <3 × 10¹⁰ | 6526 |
| With ultra sonic | <3 × 10¹⁰ | <3 × 10¹⁰ | <3 × 10¹⁰ | <3 × 10¹⁰ | 18586 |
| Particles contaminated | <3 × 10¹⁰ | <3 × 10¹⁰ | <3 × 10¹⁰ | <3 × 10¹⁰ | ˜5000 |
| wafer 53 (before cleaning) | | | | | |
| Without ultra sonic | <3 × 10¹⁰ | <3 × 10¹⁰ | <3 × 10¹⁰ | <3 × 10¹⁰ | 5625 |
| With ultra sonic | <3 × 10¹⁰ | <3 × 10¹⁰ | <3 × 10¹⁰ | <3 × 10¹⁰ | 7058 |

As is apparent from Table 5, in both cases of the metal contaminated wafer 52 and particles contaminated wafer 53, the concentration of atoms of various metals after cleaning under the conditions in the presence/absence of ultrasonic vibration is a value (not more than 3×10¹⁰ atoms/cm²) lower than the detection limit similar to the measurement results under the optimum cleaning conditions (concentration of hydrogen fluoride: 0.005 to 0.03% by weight) of Table 2. That is, high cleaning capability to contamination metals can be confirmed.

However, the number of dust particles remained on the wafer surface is large in both cases of the metal contaminated wafer 52 and particles contaminated wafer in the presence/absence of ultrasonic vibration. That is, it is found that the effect of removing contamination particles can not be expected.

It is also found that secondary particles contamination gets worse by applying an ultrasonic wave in this cleaning solution.

Accordingly, as is apparent from these results, the cleaning method according to the present invention shown in Examples 1 and 2 is particularly superior in effect of removing the contamination particles to the cleaning method (SC2 cleaning) of the prior art shown in Comparative Example 2.

### COMPARATIVE EXAMPLE 3

This Comparative Example is Comparative Example with respect to the material to be used in a cleaning bath 71.

In Comparative Example 3, the cleaning was performed under the same cleaning conditions as those of Example 1 using the same device as that of Example 1, except for using a PFA resin in place of silicon carbide as the material of the cleaning bath 71, and the evaluation was performed.

As a result, in Comparative Example 3, almost the same cleaning effect as that in case of cleaning without applying ultrasonic vibration in Example 1 was merely obtained in spite of cleaning while applying ultrasonic vibration.

This reason is considered that almost all of energy of an ultrasonic wave generated by the ultrasonic generator 12 mounted to the exterior of this cleaning bath 71 is absorbed in the cleaning bath 71 made of the PFA resin and, therefore, energy is not transmitted to the cleaning solution 41 with which the cleaning bath is filled, and the silicon wafer 1.

Accordingly, it is found that the cleaning bath 71 made of silicon carbide, which hardly absorbs vibration, is preferably used to use such a cleaning method in the present invention essentially requiring application of ultrasonic vibration.

It is found that the cleaning characteristics of the cleaning solution containing 0.05-20% by weight of hydrogen fluoride and 1-20% by weight of hydrogen peroxide described in Japanese Patent Laid-Open (Kokai) Publication No. 213354/1996 correspond to the case using not less than 0.08% by weight of hydrogen fluoride of Tables 2 and 3 and, therefore, the effect of removing dust particles is hardly exerted.

The cleaning conditions without applying an ultrasonic wave described in Japanese Patent Laid-Open (Kokai) Publication No. 115077/1995 are almost the same conditions as those of the present invention of Tables 1 and 3. As is apparent from the test results, the same results are obtained in case of cleaning at 80° C.

### EXAMPLE 3

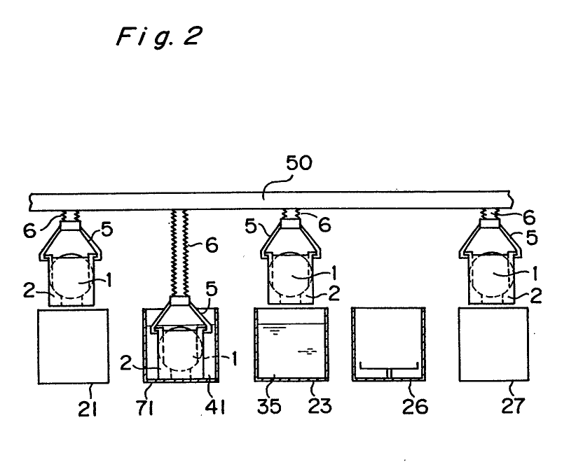

FIG. 2 is a schematic diagram showing the cleaning device of Example 3 according to the present invention. A loader 21 is provided to load a product cassette 2 containing a wafer 1 in a cleaning device. The product cassette 2 containing the loaded wafer 1 is caught by a hand 5 via an elevating actuator 6 mounted to a locomotive robot 50, and then loaded in a cleaning bath 71 filled with a cleaning solution 41 prepared by dissolving a trace amount of hydrogen fluoride and ozone in ultrapure water, where particles and metals are cleaned at the same time.

Then, the product cassette 2 and wafer 1 are transferred to a water washing bath 23 filled with ultrapure water 35 by means of the locomotive robot 50 to rinse the cleaning solution 41 adhered on the surface, where the wafer is subjected to a rinsing treatment.

Subsequently, the product cassette 2 and wafer 1 are transferred to a spin drying device 26 by means of the locomotive robot 50 again, where they are dried. The dried product cassette 2 and wafer 1 are transferred to an unloader chamber 27 by means of the locomotive robot 50, where they are unloaded from the cleaning device.

The drying is performed by using the spin drying device, but any other drying means such as IPA drying device can also be used, not specifically limited to the spin drying device.

The metal contaminated wafer 52 was dipped in a cleaning solution 33 (cleaning solution prepared by adding a different amount of hydrogen fluoride to a solution prepared by dissolving 4 ppm of ozone in ultrapure water) for 10 minutes, rinsed with pure water 35 and dried by using a spin drying device 26, and then the concentration of Fe atoms on the wafer surface and the number particles having a particle diameter of not less than 0.2 μm were examined. The results are shown in Table 6. The rinsing treatment was performed by using ultrapure water for 10 minutes.

TABLE 6

| HF | Fe | Ni | Zn | Ca | |
|---|---|---|---|---|---|
| concentration | (atoms/ | (atoms/ | (atoms/ | (atoms/ | PSL |
| (wt. %) | cm²) | cm²) | cm²) | cm²) | particles |
| Before cleaning | 2 × 10¹³ | <3 × 10¹⁰ | 4 × 10¹⁰ | 5 × 10¹⁰ | ˜6000 |
| 0.00000 | 2 × 10¹³ | <3 × 10¹⁰ | 4 × 10¹⁰ | 5 × 10¹⁰ | 5731 |
| 0.00001 | 2 × 10¹³ | <3 × 10¹⁰ | 4 × 10¹⁰ | 4 × 10¹⁰ | 6027 |
| 0.00005 | 2 × 10¹³ | <3 × 10¹⁰ | <3 × 10¹⁰ | <3 × 10¹⁰ | 5211 |
| 0.00010 | 1 × 10¹³ | <3 × 10¹⁰ | <3 × 10¹⁰ | <3 × 10¹⁰ | 1008 |
| 0.00050 | 3 × 10¹² | <3 × 10¹⁰ | <3 × 10¹⁰ | <3 × 10¹⁰ | 108 |
| 0.00100 | 2 × 10¹¹ | <3 × 10¹⁰ | <3 × 10¹⁰ | <3 × 10¹⁰ | 42 |
| 0.00500 | 4 × 10¹⁰ | <3 × 10¹⁰ | <3 × 10¹⁰ | <3 × 10¹⁰ | 26 |
| 0.01000 | <3 × 10¹⁰ | <3 × 10¹⁰ | <3 × 10¹⁰ | <3 × 10¹⁰ | 7 |
| 0.03000 | <3 × 10¹⁰ | <3 × 10¹⁰ | <3 × 10¹⁰ | <3 × 10¹⁰ | 4 |
| 0.05000 | <3 × 10¹⁰ | <3 × 10¹⁰ | <3 × 10¹⁰ | <3 × 10¹⁰ | 5 |
| 0.10000 | <3 × 10¹⁰ | <3 × 10¹⁰ | <3 × 10¹⁰ | <3 × 10¹⁰ | 26 |
| 0.30000 | <3 × 10¹⁰ | <3 × 10¹⁰ | <3 × 10¹⁰ | <3 × 10¹⁰ | 43 |
| 0.50000 | <3 × 10¹⁰ | <3 × 10¹⁰ | <3 × 10¹⁰ | <3 × 10¹⁰ | 57 |
| 1.00000 | <3 × 10¹⁰ | <3 × 10¹⁰ | <3 × 10¹⁰ | <3 × 10¹⁰ | 48 |

As is apparent from Table 6, Fe is removed to the level lower than the detection limit (not more than 3×10¹⁰ atoms/cm²) when the concentration of hydrogen fluoride is not less than 0.03% by weight.

On the other hand, with respect to removal of metal oxide particles, as is apparent from Table 6, the effect of removing metal oxide particles is recognized when the concentration of hydrogen fluoride is not less than 0.01% by weight. Furthermore, a remarkable effect of removing metal oxide particles is recognized when the concentration of hydrogen fluoride is within a range from 0.02 to 0.08% by weight. However, it gradually becomes difficult to remove metal oxide particles when the concentration of hydrogen fluoride is not less than 0.1% by weight. This reason is considered that once cleaned metal oxide particles are easily adhered/adsorbed to the wafer again, thereby to cause secondary contamination.

In the presence of high concentration ozone such as 20 ppm, a remarkable effect of removing metal oxide particles is recognized when the concentration of hydrogen fluoride is not more than 0.1% by weight. Therefore, a slightly optimum cleaning range is widen. On the other hand, when ozone is not added, any metal oxide particles could not be removed.

### EXAMPLE 4

The drying is performed by using the cleaning device shown in FIG. 2 under the same conditions as those of Example 4 except for using the particles contaminated wafer 53 in place of the metal contaminated wafer 52 used in Example 4, and the evaluation was performed.

The particles contaminated wafer 53 was cleaned by using a cleaning solution 33 for 10 minutes, and then the number of particles having a particle diameter of not less than 0.2 μm on the wafer surface was examined. The results are shown in Table 7. The rinsing treatment was performed by using ultrapure water for 10 minutes.

TABLE 7

| HF | |
|---|---|
| concentration | PSL particles |
| (wt. %) | (without ultra sonic) |
| Before cleaning | ˜5000 |
| 0.00000 | 5381 |
| 0.00001 | 863 |
| 0.00005 | 876 |
| 0.00010 | 882 |
| 0.00050 | 357 |
| 0.00100 | 67 |
| 0.00500 | 25 |
| 0.01000 | 71 |
| 0.03000 | 44 |
| 0.05000 | 55 |
| 0.10000 | 51 |
| 0.30000 | 671 |
| 0.50000 | 5761 |
| 1.00000 | 10428 |

As is apparent from Table 7, a remarkable removal of PSL particles is recognized when the concentration of hydrogen fluoride is within a range from 0.005 to 0.10% by weight. However, it gradually becomes difficult to remove PSL particles when the concentration of hydrogen fluoride is not less than 0.3% by weight. The particles contamination may have got worse when the concentration of hydrogen fluoride is not less than 0.5% by weight. This reason is considered that once cleaned PSL particles and unconfirmed particles adhered on the back surface of the wafer are easily adhered to the wafer again during the cleaning. Consequently, it is found that selection of an optimum concentration of hydrogen fluoride is required to obtain a clean wafer. However, when ozone is not added, any PSL particles could not be removed.

### EXAMPLE 5

To examine dependency of the cleaning characteristics on the ozone concentration, the cleaning was performed under the same conditions as those of Example 3 and Example 4 except for using ultrapure water having a different ozone concentration in place of ultrapure water having an ozone concentration of 4 ppm, and the evaluation was performed.

The cleaning effect to the metal contaminated wafer 52 and particles contaminated wafer 53 using PSL particles was improved with an increase of the ozone concentration from 0.1 ppm. A range of an optimum hydrogen fluoride concentration was widen, including 0.01% by weight as a center, until the ozone concentration becomes 8 ppm.

However, the range of the optimum hydrogen fluoride concentration was slightly widen when the ozone concentration is from 8 to 20 ppm, but a remarkable change was not recognized. Therefore, it is considered that almost the same high cleaning effect is maintained when the ozone concentration is not less than 8 ppm.

On the other hand, the cleaning effect to the metal contamination using the metal contaminated wafer 52 was rapidly improved with an increase of the ozone concentration ranging from 0.05 to 3 ppm. Furthermore, the hydrogen fluoride concentration reaching not less than detection limit (not more than 3×10¹⁰ atoms/cm²) is also reduced and its tendency is recognized until the ozone concentration reaches 12 ppm. As a result, the hydrogen fluoride concentration was reduced to 0.005% by weight.

### COMPARATIVE EXAMPLE 4

The cleaning was performed by using the cleaning device shown in FIG. 2 under the same conditions as those of Example 1 except for using a cleaning solution 34 prepared by dissolving ammonia and hydrogen peroxide in pure water in place of the cleaning solution 33 prepared by adding hydrogen fluoride in the amount used in Examples 3, and the evaluation was performed (corresponding to SC1 cleaning of the prior art). Such an evaluation of cleaning is the same as that of Comparative Example 1. The results are as shown in Table 4.

The characteristics of removing particles without applying an ultrasonic wave are by far inferior to the results shown in Table 6 and Table 7. On the other hand, when applying an ultrasonic wave, almost the same excellent cleaning effect (about 20) as that in case under the optimum cleaning conditions of Table 6 is exerted.

On the other hand, with respect to the metal contamination level of the wafer surface after cleaning to the metal contaminated wafer 52, the concentration of Fe atoms is high such as 5×10¹² atoms/cm², and the concentration of other metals such as Zn, Ca and the like is also slightly high. The metal contamination level of the wafer surface after cleaning to the metal contaminated wafer 53 also becomes higher than the contaminated state before cleaning. Accordingly, it is found that the cleaning of the prior art shown in Comparative Example 3 is inferior to the cleaning of Example 3.

### COMPARATIVE EXAMPLE 5

The cleaning was performed by using the cleaning device shown in FIG. 2 under the same conditions except for using a cleaning solution 35 prepared by dissolving hydrochloric acid and hydrogen peroxide in pure water in place of the cleaning solution 33 prepared by adding hydrogen fluoride in the amount used in Example, and the evaluation was performed (corresponding to SC2 cleaning of the prior art). Such an evaluation of cleaning is the same as that of Comparative Example 2. The results are as shown in Table 5.

As is apparent from Table 5, the concentration of atoms of various metals after cleaning is lower than the detection limit (3×10¹⁰) similar to the results of Example 3 under the optimum conditions of Table 6. That is, high cleaning capability can be confirmed.

On the other hand, the number of remained particles is large in both cases of the metal contaminated wafer 52 and particles contaminated wafer 53, and it is found that the effect of removing particles can not be expected (in comparison with the results of Example 3 under the optimum conditions of Table 6).

Accordingly, it is found that the cleaning of the prior art shown in Comparative Example 4 is inferior to the cleaning shown in Example 3 and Example 4.

### EXAMPLE 6

FIG. 1 is a schematic diagram showing the construction of the cleaning device of Example 6. The device shown in FIG. 1 is the same as that shown in FIG. 2 except for the following point.

The cleaning device shown in FIG. 1 is different from the cleaning device shown in FIG. 2 in that an ultrasonic generator 12 (manufactured by Honda Denshi Co., Ltd., frequency: 800 kHz, dissipation power: 30 W) is mounted to the exterior of a cleaning bath 71. The cleaning bath 71 is made of a material, which does not dissolve in the cleaning solution 41 and hardly causes damping of an ultrasonic wave generated by the ultrasonic generator 12, for example, silicon carbide.

The cleaning device shown in FIG. 1 is the same as that used in Example 1.

Then, its operation will be described. A product cassette 2 containing a wafer 1 loaded in a loader 21 is caught by a hand 5 via an elevating actuator 6 mounted to a locomotive robot 50, and then loaded in a cleaning bath 71 filled with a cleaning solution 41 prepared by dissolving a trace amount of hydrogen fluoride and ozone. Subsequently, an ultrasonic wave of not less than 100 kHz is applied by the ultrasonic generator 12 in the cleaning solution, thereby cleaning particles and metals at the same time. The product cassette 2 and wafer 1 are transferred to a water washing bath 23 filled with ultrapure water 35 by means of the locomotive robot 50, where they are subjected to a rinsing treatment to rinse the cleaning solution 41 adhered on the surface.

The production cassette 2 and wafer 1 are transferred to a spin drying device 26 by means of the locomotive robot 50, where they are dried. The dried product cassette 2 and wafer 1 are transferred to an unloader 27 by means of the locomotive robot 50, where they are unloaded. The drying is performed by using the spin drying device, but other drying devices such as IPA vapor drying device can also be used, not limited to the spin drying device.

The results are shown in Table 8. There is shown the case where the wafer is cleaned by using a cleaning solution 33 with applying an ultrasonic wave to the metal contaminated wafer 52 for 10 minutes. The number of particles having a particle diameter of 0.2 μm are shown, together with the concentration of Fe atoms on the wafer surface. The cleaning solution 33 is a cleaning solution prepared by adding a different amount of hydrogen fluoride to a solution prepared by dissolving 4 ppm of ozone in ultrapure water. Furthermore, the rinsing was performed by using ultrapure water for 10 minutes.

TABLE 8

| HF | Fe | Ni | Zn | Ca | |
|---|---|---|---|---|---|
| concentration | (atoms/ | (atoms/ | (atoms/ | (atoms/ | PSL |
| (wt. %) | cm²) | cm²) | cm²) | cm²) | particles |
| Before cleaning | 2 × 10¹³ | <3 × 10¹⁰ | 4 × 10¹⁰ | 5 × 10¹⁰ | ˜6000 |
| 0.00000 | 2 × 10¹³ | <3 × 10¹⁰ | 4 × 10¹⁰ | 5 × 10¹⁰ | 5446 |
| 0.00001 | 2 × 10¹³ | <3 × 10¹⁰ | 4 × 10¹⁰ | 4 × 10¹⁰ | 5642 |
| 0.00005 | 2 × 10¹³ | <3 × 10¹⁰ | <3 × 10¹⁰ | <3 × 10¹⁰ | 5211 |
| 0.00010 | 1 × 10¹³ | <3 × 10¹⁰ | <3 × 10¹⁰ | <3 × 10¹⁰ | 908 |
| 0.00050 | 2 × 10¹² | <3 × 10¹⁰ | <3 × 10¹⁰ | <3 × 10¹⁰ | 87 |
| 0.00100 | 1 × 10¹¹ | <3 × 10¹⁰ | <3 × 10¹⁰ | <3 × 10¹⁰ | 32 |
| 0.00500 | <3 × 10¹⁰ | <3 × 10¹⁰ | <3 × 10¹⁰ | <3 × 10¹⁰ | 4 |
| 0.01000 | <3 × 10¹⁰ | <3 × 10¹⁰ | <3 × 10¹⁰ | <3 × 10¹⁰ | 0 |
| 0.03000 | <3 × 10¹⁰ | <3 × 10¹⁰ | <3 × 10¹⁰ | <3 × 10¹⁰ | 0 |
| 0.05000 | <3 × 10¹⁰ | <3 × 10¹⁰ | <3 × 10¹⁰ | <3 × 10¹⁰ | 0 |
| 0.10000 | <3 × 10¹⁰ | <3 × 10¹⁰ | <3 × 10¹⁰ | <3 × 10¹⁰ | 3 |
| 0.30000 | <3 × 10¹⁰ | <3 × 10¹⁰ | <3 × 10¹⁰ | <3 × 10¹⁰ | 11 |
| 0.50000 | <3 × 10¹⁰ | <3 × 10¹⁰ | <3 × 10¹⁰ | <3 × 10¹⁰ | 27 |
| 1.00000 | <3 × 10¹⁰ | <3 × 10¹⁰ | <3 × 10¹⁰ | <3 × 10¹⁰ | 39 |

As is apparent from Table 8, Fe is removed until the concentration reaches not more than the detection limit (not more than 3×10¹⁰ atoms/cm²) when the concentration of hydrogen fluoride is not less than 0.005% by weight.

As is apparent from Table 8, particles of the metal oxide are removed when the concentration of hydrogen fluoride is not less than 0.005% by weight. Furthermore, when the concentration of hydrogen fluoride is within a range from 0.05 to 0.1% by weight, the effect of removing metal oxide particles is remarkably recognized. However, it gradually becomes difficult to remove metal oxide particles when the concentration of hydrogen fluoride is not less than 0.3% by weight. This reason is considered that once cleaned metal oxide particles are easily adhered/adsorbed to the wafer again during the cleaning, thereby causing secondary contamination. Consequently, it is found that selection of an optimum concentration of hydrogen fluoride is required to obtain a clean wafer. However, when the concentration of ozone is slightly high such as 20 ppm, the effect of removing metal oxide particles is remarkably recognized when the concentration of hydrogen fluoride is not more than 0.05% by weight. Therefore, the optimum cleaning range is slightly widen. On the other hand, when ozone is not added, any PSL particles could not be removed.

### EXAMPLE 7

The drying is performed by using the cleaning device shown in FIG. 2 under the same conditions as those of Example 3 except for using the particles contaminated wafer 53 in place of the metal contaminated wafer 52 used in Example 4.

The results are shown in Table 9.

TABLE 9

| HF | | |
|---|---|---|
| concentration | PSL particles | PSL particles |
| (wt. %) | (without ultra sonic) | (with ultra sonic) |
| Before cleaning | ˜5000 | ˜5000 |
| 0.00000 | 5381 | 26 |
| 0.00001 | 863 | 22 |
| 0.00005 | 876 | 14 |
| 0.00010 | 882 | 7 |
| 0.00050 | 357 | 4 |
| 0.00100 | 67 | 2 |
| 0.00500 | 25 | 0 |
| 0.01000 | 71 | 0 |
| 0.03000 | 44 | 0 |
| 0.05000 | 55 | 1 |
| 0.10000 | 51 | 5 |
| 0.30000 | 671 | 23 |
| 0.50000 | 5761 | 78 |
| 1.00000 | 10428 | 382 |

In Table 9, the results obtained by examining the number of particles having a particle diameter of not less than 0.2 μm on the wafer surface in case of cleaning the particles contaminated wafer 53 using the cleaning solution 33 are shown. It has been found that a remarkable removal of PSL particles was recognized when the concentration of hydrogen fluoride is within a range from 0.001 to 0.30% by weight. However, it gradually becomes difficult to remove PSL particles when the concentration of hydrogen fluoride is not less than 0.3% by weight. The particles contamination may have got worse when the concentration of hydrogen fluoride is not less than 0.5% by weight. This reason is considered that once cleaned PSL particles and unconfirmed particles adhered on the back surface of the wafer are easily adhered to the wafer again during the cleaning. Consequently, it is found that selection of an optimum concentration of hydrogen fluoride is required to obtain a clean wafer. However, when ozone is not added, any PSL particles could not be removed.

As is apparent from a comparison between Table 6 and Table 8, the cleaning effect to the particles contamination is enhanced by applying an ultrasonic wave. As is also apparent from Table 9, the cleaning effect to the particles contamination is enhanced by applying an ultrasonic wave. As is apparent from a comparison between Table 6 and Table 8, the cleaning effect to the metal contamination is enhanced by applying an ultrasonic wave.

### EXAMPLE 8

To examine dependency of the cleaning characteristics on the ozone concentration, the cleaning was performed under the same conditions as those of Example 6 and Example 7 except for using ultrapure water having a different ozone concentration in place of ultrapure water having an ozone concentration of 4 ppm, and the evaluation was performed.

The cleaning effect to the metal contaminated wafer 52 and particles contaminated wafer 53 using PSL particles (cleaning effect to particles contamination) was improved with an increase of the ozone concentration from 0.1 ppm. A range of an optimum hydrogen fluoride concentration was widen, including 0.01% by weight as a center, until the ozone concentration becomes 12 ppm. However, the range of the optimum hydrogen fluoride concentration was slightly widen when the ozone concentration is from 12 to 20 ppm, but a remarkable change was not recognized. Therefore, it is considered that almost the same high cleaning effect is maintained when the ozone concentration is not less than 12 ppm.

On the other hand, the cleaning effect to the metal contamination using the metal contaminated wafer 52 (cleaning effect to metal contamination) was rapidly improved with an increase of the ozone concentration ranging from 0.03 to 2 ppm. Furthermore, the hydrogen fluoride concentration reaching not less than detection limit (not more than 3×10¹⁰ atoms/cm²) is also reduced and its tendency is recognized until the ozone concentration reaches 10 ppm. As a result, the hydrogen fluoride concentration was reduced to 0.001% by weight.

As is apparent from the above description, by using the method of cleaning a silicon wafer according to the present invention, it is possible to remove contamination particles and contamination trace metals, which have been removed in a separate step in the RCA method of the prior art. Furthermore, since the addition of the surfactant is not required, it becomes possible to simplify the cleaning step and to reduce the production cost.

By removing contamination particles and contamination trace metals at the same time, particularly, it becomes possible to prevent readhesion of the other contaminant in the step of removing one contaminant, which has occurred in the RCA method of the prior art, thereby making it possible to obtain a clean silicon wafer with little contamination.

Such a silicon wafer having a remarkably clean surface is essential to improve the production yield of VLSI such as DRAM.

Since only one kind of a cleaning solution is used and its concentration is remarkably low, it becomes possible to reduce the amount of chemicals and the amount of ultrapure water required to rinse the cleaning solution from the wafer surface, and to reduce the production step and production cost.

Furthermore, such a cleaning step accompanies the etching reaction of silicon oxide due to hydrogen fluoride but the cleaning solution can be used at room temperature and, therefore, the etch rate can be easily controlled.

Furthermore, since the heating of the cleaning solution is not required, it becomes possible to reduce the running cost.

In the cleaning bath according to the present invention, by using a material, which does not dissolve in hydrogen fluoride, in the cleaning bath, it becomes possible to provide a cleaning device which is superior in safety and durability. Furthermore, since ultrasonic vibration is hardly absorbed, it becomes possible to effectively use vibration produced by an ultrasonic generator in the cleaning of the wafer.

According to the present invention, by using the method of cleaning a wafer by dipping in a cleaning solution prepared by dissolving a trace amount of hydrogen fluoride and ozone in ultrapure water, contamination particles and contamination trace metals can be removed at the same time. Therefore, there can be obtained such an effect that a problem of secondary contamination, which occurs during the cleaning, can be eliminated.

Since only one kinds of the cleaning solution is used, a portable cleaning device having high throughput can be provided.

Since only one kind of a cleaning solution is used and its concentration is very low, it becomes possible to reduce the amount of ultrapure water required to rinse the cleaning solution from the wafer surface. Therefore, there can be obtained such an effect that realization of a cleaning process, which does not exert a harmful influence on the global environment, and realization of a portable cleaning device having high throughput can be attained.

What is claimed is:

1. A method of cleaning a silicon wafer, which comprises dipping the silicon wafer in a cleaning solution comprising an aqueous solution containing low concentration hydrogen fluoride and hydrogen peroxide while applying ultrasonic vibration to the silicon wafer.

2. The method as claimed in claim 1, wherein the concentration of hydrogen fluoride is from 0.0005 to 0.05% by weight.

3. The method as claimed in claim 1, wherein the concentration of hydrogen peroxide is from 0.0001 to 50% by weight.

4. The method as claimed in claim 1, wherein the vibration frequency of ultrasonic vibration is not less than 100 kHz.

5. A method of cleaning a silicon wafer, which comprises dipping a silicon wafer in a cleaning solution comprising an aqueous solution prepared by dissolving not less than 0.0005% by weight of hydrogen fluoride and ozone.

6. The method as claimed in claim 5, wherein the concentration of hydrogen fluoride is from 0.001 to 0.3% by weight.

7. The method as claimed in claim 5, wherein the concentration of ozone is not less than 0.1 ppm.

8. The method as claimed in claim 5, which comprises dipping a silicon wafer in a cleaning solution comprising an aqueous solution prepared by dissolving from 0.0005 to 0.5% by weight of hydrogen fluoride and not less than 0.1 ppm of ozone, and applying ultrasonic wave of not less than 100 kHz to the silicon wafer.

9. The method as claimed in claim 8, wherein the cleaning solution comprising an aqueous solution prepared by dissolving from 0.001 to 0.3% by weight of hydrogen peroxide and not less than 2 ppm of ozone.

10. A device for cleaning a silicon wafer, which comprises a bath for storing a cleaning solution comprising an aqueous solution containing low concentration hydrogen fluoride and hydrogen peroxide, said cleaning bath further comprising an ultrasonic wave generator for applying ultrasonic vibration to a silicon wafer dipped in the cleaning solution.

11. The device as claimed in claim 10, wherein the cleaning bath is made of silicon carbide.

12. The device as claimed in claim 10, further comprising a water washing bath for washing the silicon wafer cleaned in the cleaning bath, and a drier for drying the silicon wafer washed with water in the water washing bath.

13. The device as claimed in claim 10, further comprising a loader chamber, a transfer means for transferring the silicon wafer from the loader chamber to the cleaning bath.

14. The device as claimed in claim 13, wherein the concentration of hydrogen fluoride is from 0.0005 to 0.5% by weight and the concentration of ozone is not less than 0.1 ppm in the bath, and wherein the ultrasonic generating means is capable of applying an ultrasonic wave of not less than 100 kHz to the cleaning solution.

15. A semiconductor element cleaned by dipping in a cleaning solution comprising an aqueous solution containing low concentration hydrogen fluoride and hydrogen peroxide while applying ultrasonic vibration.

16. A semiconductor element cleaned by dipping in a cleaning solution comprising an aqueous solution prepared by dissolving not less than 0.0005% by weight of hydrogen fluoride and ozone.
